(19) United States
(12) Patent Application Publication
(10) Pub. No.: US 2026/0304011 A1
(43) Pub. Date: Oct. 1, 2026

(54) SILICON BACKPLANES FOR A LIQUID CRYSTAL ON SILICON (LCOS) PHASE MODULATOR

(71) Applicant: Molex, LLC, Lisle, IL (US)

(72) Inventors: Chongchang Mao, Fremont, CA (US); Lianhua Ji, Erie, CO (US)

(21) Appl. No.: 19/578,880

(22) Filed: Mar. 26, 2026

Related U.S. Application Data
(60) Provisional application No. 63/779,400, filed on Mar. 28, 2025.

(51) Int. Cl. H04Q 11/00; H04J 14/02

(52) U.S. Cl. CPC H04Q 11/0005; H04J 14/0212; H04J 14/03; H04Q 2011/0016; H04Q 2213/038

(57) ABSTRACT

A liquid crystal on silicon (LCOS) device may include a circuit for controlling an electrode of a LCOS backplane phase modulator. The circuit may support high alternating current (AC) frequency driving of the electrode by including data update transistors that are configured to switch at a frequency that is independent of, and higher than, a frequency at which data signals for positive and negative data frames are stored to storage units of the circuit. Alternatively, the circuit may support improving voltage stability at the electrode by providing continuous charging to a storage unit coupled with the electrode. For example, the circuit may include data update transistors that are each configured to transfer respective charges to the storage unit via a source follow transistor that is coupled to each of the data update transistors.

### FIELD OF THE INVENTION

The present disclosure relates generally, but is not limited, to liquid crystal on silicon (LCOS) devices. More specifically, the present disclosure relates to silicon backplanes for a LCOS phase modulator.

### BACKGROUND

Liquid crystal on silicon (LCOS) devices are known in the art for use as optical phase modulators, among other applications. These devices can spatially manipulate optical signals and have many applications, including beam steering, image display, spectral compensation, and front wave shaping. A LCOS device may include, among other components, metal mirrors on a silicon backplane. The mirrors may form a two-dimensional (2-D) array of individually addressable pixels. Each pixel is individually drivable by a voltage signal to provide a local phase change to an optical signal, thereby providing a 2-D array of phase-manipulating regions.

Electrodes on the silicon backplane may include a 2-D array of pixel circuits for controlling the pixels, and the pixel circuits may be arranged according to various circuit schematics. Among these, in recent years, frame buffer pixel circuit technology has gained significant interest from researchers and industry engineers. For example, compared to conventional LCOS phase modulators, an LCOS phase modulator incorporating a frame buffer pixel circuit offers a higher image contrast ratio and a high grayscale, among other benefits. However, previous frame buffer pixel circuits face challenges in achieving high alternating current (AC) frequency driving for pixels and maintaining a high voltage holding ratio (VHR). The potential voltage instability at each pixel leads to phase fluctuations in the LCOS phase modulator. Previous technologies are poorly suited for applications requiring strict flicker control, such as LCOS phase modulators in wavelength selective switches (WSS) for telecom networks.

### SUMMARY

Embodiments of improved silicon backplanes for a liquid crystal on silicon (LCOS) phase modulator are disclosed herein. According to a first aspect of the disclosure, a circuit for controlling an electrode of a LCOS backplane phase modulator may include a first data transfer transistor; a second data transfer transistor; a first storage unit coupled with the first data transfer transistor and configured to store a first data signal for a positive data frame transferred via the first data transfer transistor; and a second storage unit coupled with the second data transfer transistor and configured to store a second data signal for a negative data frame transferred via the second data transfer transistor. The circuit may further include a first voltage source configured to increase a voltage of the first storage unit; a second voltage source configured to increase a voltage of the second storage unit; a first source follower transistor coupled with the first storage unit; and a second source follower transistor coupled with the second storage unit. The circuit may further include a first data update transistor coupled with the first source follower transistor; a second data update transistor coupled with the second source follower transistor; a third storage unit coupled with the electrode of the LCOS backplane phase modulator; and a pull-down transistor configured to discharge a capacitance of a node common to the first data update transistor, the second data update transistor, and the third storage unit. The first data update transistor may be configured to transfer a first charge to the third storage unit based at least in part on the first data signal for the positive data frame. The second data update transistor may be configured to transfer a second charge to the third storage unit based at least in part on the second data signal for the negative data frame. The circuit may be configured to switch between activating the first data update transistor and the second data update transistor at a first frequency that is independent of a second frequency at which data signals for positive and negative data frames are stored to the first and second storage units.

According to a second aspect of the disclosure, a LCOS device may include a transparent glass substrate; a transparent electrode; a silicon backplane; and liquid crystal disposed between the silicon backplane and the transparent electrode. The LCOS device may further include an array of mirrors disposed on the silicon backplane, where the silicon backplane includes a plurality of the circuit according to the first aspect, each circuit of the plurality coupled with a respective mirror of the array of mirrors, the respective mirror being the electrode coupled with the third storage unit of each circuit.

According to a third aspect of the disclosure, a method for operating a circuit to control an electrode of a LCOS backplane phase modulator may include: storing, via a first data transfer transistor of the circuit, a first data signal for a positive data frame to a first storage unit of the circuit; storing, via a second data transfer transistor of the circuit, a second data signal for a negative data frame to a second storage unit of the circuit; increasing, using a first voltage source of the circuit, a first voltage of the first storage unit; and increasing, using a second voltage source of the circuit, a second voltage of the second storage unit. The method may further include activating a first data update transistor of the circuit to transfer a first charge from the first storage unit to a third storage unit of the circuit that is coupled with the electrode of the LCOS backplane phase modulator via the first data update transistor and a first source follower transistor of the circuit; and activating a second data update transistor of the circuit to transfer a second charge from the second storage unit to the third storage unit via the second data update transistor and a second source follower transistor of the circuit. The method may further include switching activation of the first data update transistor and the second data update transistor at a first frequency that is independent of a second frequency at which data signals for positive and negative frames are stored to the first and second storage units.

According to a fourth aspect of the disclosure, A circuit for controlling an electrode of a LCOS backplane phase modulator may include: a first data transfer transistor; a second data transfer transistor; a first storage unit coupled with the first data transfer transistor and configured to store a first data signal for a positive data frame transferred via the first data transfer transistor; and a second storage unit coupled with the second data transfer transistor and configured to store a second data signal for a negative data frame transferred via the second data transfer transistor. The circuit may further include a first voltage source configured to increase a voltage of the first storage unit; a second voltage source configured to increase a voltage of the second storage unit; a first data update transistor coupled with the first storage unit; and a second data update transistor coupled with the second storage unit. The circuit may further include a source follower transistor coupled with the first data update transistor and the second data update transistor; a third storage unit coupled with the electrode of the LCOS backplane phase modulator; a first pull-down transistor configured to discharge a capacitance of a gate of the source follower transistor; and a second pull-down transistor configured to discharge a capacitance of a node common to the source follower transistor and the third storage unit. The first data update transistor may be configured to transfer a first charge to the third storage unit via the source follower transistor based at least in part on the first data signal for the positive data frame. The second data update transistor may be configured to transfer a second charge to the third storage unit via the source follower transistor based at least in part on the second data signal for the negative data frame.

According to a fifth aspect of the disclosure, a LCOS device may include: a transparent glass substrate; a transparent electrode; a silicon backplane; and liquid crystal disposed between the silicon backplane and the transparent electrode. The LCOS device may further include an array of mirrors disposed on the silicon backplane, where the silicon backplane may include a plurality of the circuit according to the fourth aspect, each circuit of the plurality coupled with a mirror of the array of mirrors, the respective mirror being the electrode coupled with the third storage unit of each circuit.

According to a sixth aspect of the disclosure, a method for operating a circuit to control an electrode of a LCOS backplane phase modulator may include: storing, via a first data transfer transistor of the circuit, a first data signal for a positive data frame to a first storage unit of the circuit; increasing, using a first voltage source of the circuit, a first voltage of the first storage unit; and activating a first data update transistor of the circuit to transfer a first charge from the first storage unit to a second storage unit of the circuit that is coupled with the electrode of the LCOS backplane phase modulator via the first data update transistor and a source follower transistor of the circuit. The method may further include storing, via a second data transfer transistor of the circuit and during the activation of the first data update transistor, a second data signal for a negative data frame to a third storage unit of the circuit; increasing, using a second voltage source of the circuit, a second voltage of the third storage unit; and activating a second data update transistor of the circuit to transfer a second charge from the second storage unit to the third storage unit via the second data update transistor and the source follower transistor of the circuit.

According to a seventh aspect of the disclosure, a circuit for driving data signals to control electrodes of a LCOS backplane phase modulator may include: ramp signal input circuitry configured to input positive and negative ramp signals; shift registers configured to receive serial digital data inputs; and data registers configured to latch rows of pixel data for controlling the electrodes. The circuit may further include signal comparators configured to receive the pixel data and a clock signal and generate output signals based at least in part on the pixel data and the clock signal; and sample-hold circuitry configured to receive the output signals from the signal comparators and the positive and negative ramp signals from the ramp signal input circuitry and to output analog data signals for positive and negative data frames based at least in part on the output signals and the positive and negative ramp signals.

### BRIEF DESCRIPTION OF DRAWINGS

To facilitate a fuller understanding of the present disclosure, reference is now made to the appended drawings. The drawings should not be construed as limiting the present disclosure but are intended only to illustrate different aspects and embodiments of the disclosure.

FIG. 1 depicts a liquid silicon on crystal (LCOS) device in accordance with embodiments of the present disclosure.

FIG. 2 depicts a frame buffer pixel circuit in accordance with the prior art.

FIGS. 3A, 3B, and 4 depict pixel circuits in accordance with embodiments of the present disclosure.

FIG. 5 depicts a driving circuit in accordance with embodiments of the present disclosure.

### DETAILED DESCRIPTION

In the following description, for the purposes of explanation, numerous specific details are set forth to provide a thorough understanding of examples in the present disclosure. It will be apparent, however, that the examples may be practiced without these specific details. In other instances, well-known structures and devices are shown in block diagram form in order to avoid unnecessarily obscuring the examples.

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of examples do not represent all implementations consistent with the disclosure. Instead, they are merely examples of apparatuses and methods consistent with aspects related to the disclosure as recited in the appended claims.

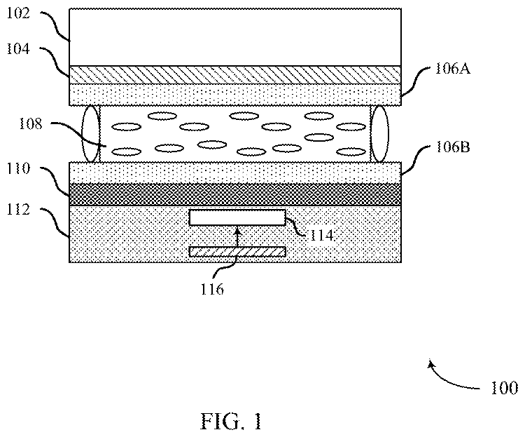

FIG. 1 depicts a LCOS device 100 that supports improved silicon backplanes for a LCOS phase modulation in accordance with one or more aspects of the present disclosure. The LCOS device 100 may include a transparent glass substrate 102 and a transparent electrode 104. In some examples, the transparent electrode 104 may be referred to as a Vcom electrode. The transparent electrode 104 may be conductive. In some examples, the transparent electrode 104 may be or include an Indium Tin Oxide (ITO) layer. The LCOS device 100 may further include a mirror 110 (e.g., a metal mirror). In some examples, the mirrors of the array may be reflective electrodes. The mirror 110 may be located (e.g., mounted, disposed) on a silicon substrate, which may include a silicon backplane 112. Although FIG. 1 depicts a single mirror 110, the LCOS device 100 may include an array of mirrors 110 to form a two-dimensional (2-D) array of individually addressable (e.g., drivable, controllable) pixels. Each pixel (e.g., mirror 110) may be individually drivable by a voltage signal to provide a local phase change to an optical signal. As such, the array of mirrors 110 may provide a 2-D array of phase-manipulating regions. LC material 108 of the LCOS device 100 may be located (e.g., disposed) between the mirror 110 and the transparent glass substrate 102 and electrode 104. In some examples, the LCOS device 100 may include spacers to separate LC material 108 associated with each mirror 110. In some examples, the LC material 108 may be pre-aligned using alignment layers 106 (e.g., two alignment layers 106A and 106B), which may be applied to the surfaces of the transparent electrode 104 (e.g., or glass substrate 102) and the silicon substrate.

The silicon backplane 112 may include a circuit 114 (e.g., a pixel circuit) that supports driving (e.g., controlling, addressing) a pixel (e.g., mirror 110) of the LCOS device 100. For example, the circuit 114 may drive a voltage signal to the mirror 110 to control the mirror 110 such that the mirror 110 provides a local phase change to an optical signal. The silicon backplane 112 may include an array of circuits 114 to drive the array of the mirrors 110. For example, the silicon backplane 112 may include a circuit 114 for each mirror 110 of the array of mirrors 110, where each circuit 114 is coupled with and may control a respective mirror 110.

In some examples, the circuit 114 may support high AC frequency driving of the mirror 110 in accordance with examples disclosed herein. For example, the circuit 114 may include data update transistors that are configured to switch at a frequency that is independent of (e.g., and higher than) a frequency at which data signals for positive and negative data frames are stored to storage units of the circuit 114. As such, the circuit 114 may support rapid switching between providing positive and negative frame data to the mirror 110 (e.g., an LC capacitor of the circuit 114 used to control the mirror 110) to achieve high AC frequency driving. The high-frequency switching between the data update transistors enables the LCOS phase modulators to reduce phase flickering, which is essential for certain applications, such as a wavelength selective switch (WSS). High AC frequency driving further helps reduce ion-charge accumulation on the mirror 110 and minimizes the flexoelectric effect, thereby reducing the phase flickering of LCOS phase modulators.

In some examples, the circuit 114 may support improving voltage stability (e.g., maintaining a high VHR) at the mirror 110 by providing continuous charging to an LC capacitor. For example, the circuit 114 may include data update transistors that are each configured to transfer respective charges to an LC capacitor of the circuit 114 based on a data signal for a positive or a negative data frame. The data update transistors may transfer the charges to the LC capacitor via a source follow transistor that is coupled to each of the data update transistors. The circuit 114 may activate and deactivate the data update transistors such that the source follower transistor continuously charges the LC capacitor. As such, the circuit 114 may continuously charge the LC capacitor within one frame time, greatly enhancing voltage stability. The source follower transistor may also be configured to isolate the storage units of the circuit configured to store data signals for positive and negative data frames from the LC capacitor, further improving voltage stability applied to the LC capacitor. The increased stability of the pixel output voltage also reduces phase flickering in LCOS phase modulators.

The LCOS device 100 (e.g., the silicon backplane 112) may include a driving circuit 116 configured to drive data to the circuit 114. For example, the driving circuit 116 may be configured to drive data signals for positive data frames and negative data frames to the circuit 114. In some examples, the driving circuit 116 may be coupled with the array of circuits 114 and drive respective data to each circuit 114 of the array of circuits 114. The driving circuit 116 may include comparator and sample-hold circuitry that enables a simplified digital-to-analog converter (DAC)-type column driver that supports using a variety of waveforms for the positive and negative input signals (e.g., as opposed to being limited to a sawtooth waveform). Alternative waveforms, such as a ramp waveform, may facilitate Gamma calibration and DC bias fine-tuning through the optimization of waveforms of positive and negative input ramp signals. The driving circuit 116 may be a simpler circuit relative to (e.g., that occupies less space than) conventional resistive-DAC (R-DAC) column drivers by utilizing positive and negative input signals (e.g., ramp signals) that are externally generated (e.g., generated by an external driving board of the LCOS device 100 (not shown)). The sample-hold DAC of the driving circuit 116 may further support higher resolution compared to the conventional R-DAC commonly implemented in LCOS and (thin film transistor) TFT column drivers.

The systems and techniques for silicon backplanes in a LCOS described herein may be generally implemented to improve the performance of various devices and systems. For example, a Reconfigurable Add/Drop Multiplexer (ROADM) may enable the addition of new services to telecom networks without the need for costly upgrades or significant changes. A ROADM may allow for remote, precise, and flexible wavelength selection, significantly increasing network capacity at a lower cost. LCOS phase modulators are widely used in wavelength selective switch (WSS) systems, which are core subsystems of ROADM systems. Conventional LCOS phase modulators are limited to only perform polarization-dependent phase modulation, meaning the light polarization must be carefully controlled, leading to complex optical systems. The pixel circuits described herein may be used in polarization-independent LCOS (PI-LCOS) phase modulators. PI-LCOS phase modulators allow WSS systems to have simpler optical designs, enhanced performance, and lower costs compared to systems using traditional polarization-dependent LCOS phase modulators.

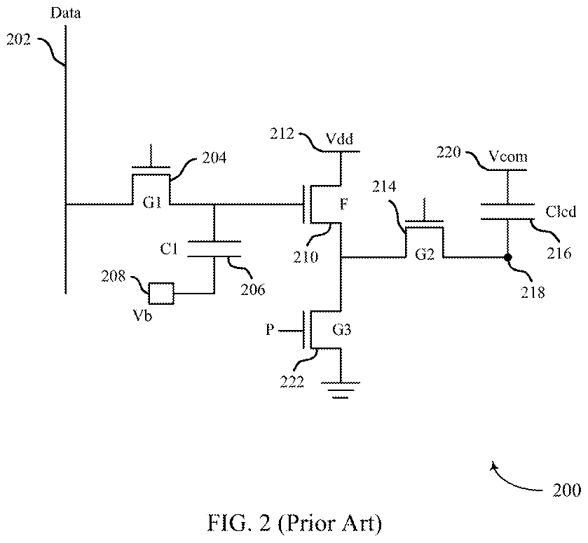

FIG. 2 depicts a frame buffer pixel circuit 200 implemented in a LCOS device in accordance with the prior art. The circuit 200 includes a data pass gate transistor G1 204, a capacitor C1 206, a voltage booster 208, a source follower transistor F 210, a pull-down transistor G3 222, and a data pass gate transistor G2 214. The circuit 200 further includes a capacitor Clcd 216 used to control a mirror (e.g., an electrode) of the LCOS device. A voltage source Vdd 212 may be coupled with a node (e.g., a drain) of the source follower transistor F 210. The capacitor Clcd 216 may be coupled with the data pass gate transistor G2 214 and a voltage source Vcom 220. A node 218 (e.g., a pixel electrode (PE) node) may be common to the capacitor Clcd 216 and the data pass gate transistor G2 214.

When the data pass gate transistor G1 204 is activated by the circuit 200, data from a data line 202 is transferred to the drain of the data pass gate transistor G1 204 and stored in the capacitor C1 206. After the capacitor C1 206 is fully charged, the circuit 200 closes the data pass gate transistor G1 204. After the entire frame data are loaded into respective C1 capacitors in all pixels of the LCOS device, respective data pass gate transistors G2 214 in all pixels are simultaneously activated (e.g., the gates of these transistors are opened). Activating the data pass gate transistors G2 214 transfers the entire frame data via respective source follower transistors F 210 to charge respective capacitors Clcd 216 and parasitic capacitors. After the respective capacitors Clcd 216 are fully charged, the data pass gate transistors G2 214 are deactivated (e.g., the gates of these transistors are closed). The pull-down transistor G3 is used to discharge residual capacitance at the node 218 before respective capacitors Clcd 216 are charged.

To increase the output voltage range of the circuit 200, the circuit may use the voltage booster 208 to apply a boosting voltage Vb to the capacitor C1 206. During operation, the voltage booster 208 is initially set to zero volts while data is transferred to the capacitor C1 206 through the data pass gate transistor G1 204. After the frame data is fully loaded into the capacitors C1 206 across all pixels, the voltage booster 208 is raised to a predefined voltage (e.g., boosting voltage Vb) to increase a charge of the capacitor C1 206, and the data pass gate transistors G2 214 in all pixels are simultaneously activated (e.g., opened) to charge the capacitors Clcd 216. Before loading the next frame of data, the voltage booster 208 is reset to zero volts. This process is continuously repeated throughout the LCOS operation.

While the circuit 200 provides various advantages over conventional LCOS phase modulators (e.g., higher image contrast ratio and grayscale, enhanced optical power efficiently, and so on), the circuit 200 also has a number of limitations. For example, it is difficult to achieve high AC driving frequency (e.g., in the kilohertz (kHz) range) and/or a high VHR of the capacitor Clcd 216 using the circuit 200. LCOS phase modulators with lower AC driving frequency typically exhibit high phase flickering due to free ion-charge accumulation on the electrodes and the liquid crystal flexoelectric effect. A lower VHR at the capacitor Clcd 216 is also associated with higher phase flickering. The potential voltage instability at each pixel associated with lower AC driving frequencies VHRs leads to phase fluctuations in the LCOS phase modulator. Some applications, however, require strict flicker control, such as LCOS phase modulators in WSSs for telecom networks, among other examples.

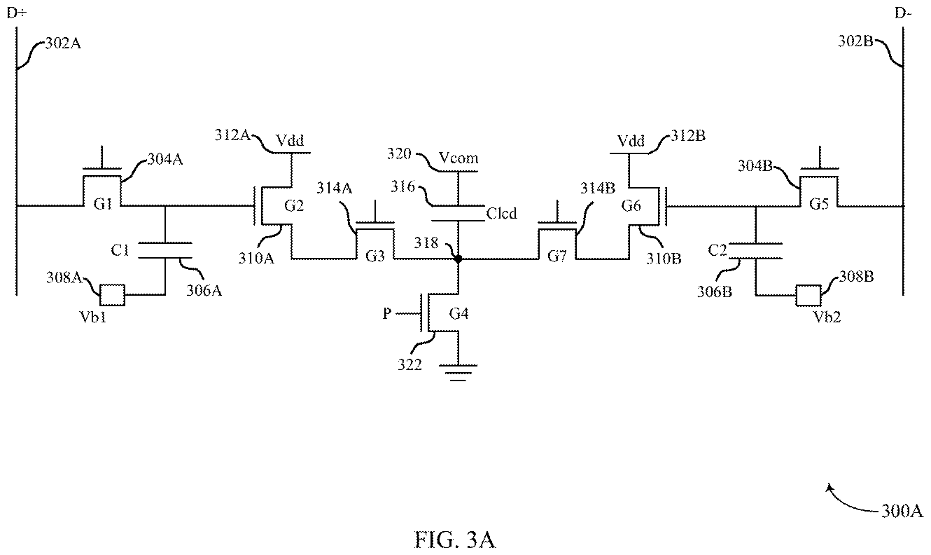

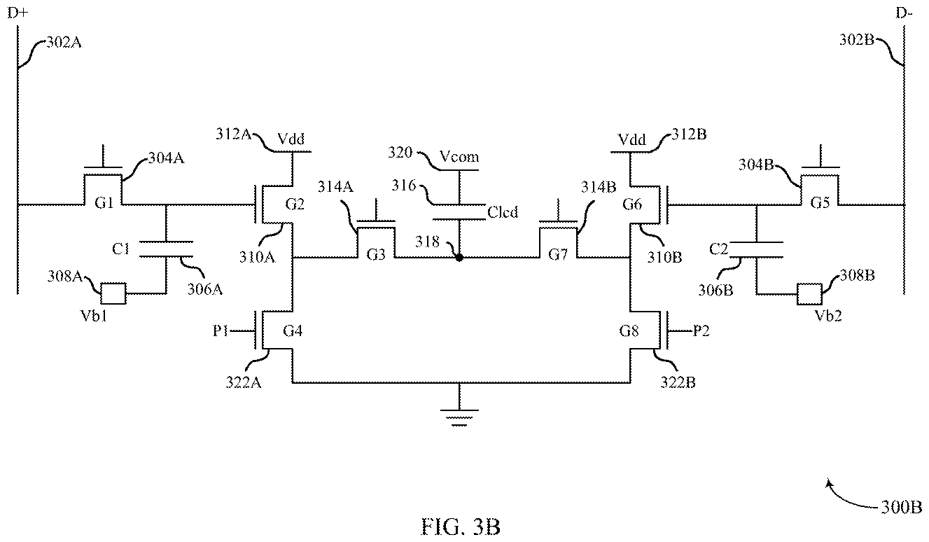

FIGS. 3A and 3B depict pixel circuits 300A and 300B, respectively, that support improved silicon backplanes for a LCOS phase modulation in accordance with one or more aspects of the present disclosure. The pixel circuits 300A and 300B may be implemented in a LCOS device 100, as described with reference to FIG. 1. For example, the pixel circuits 300A and 300B may be examples of a circuit 114 described with reference to FIG. 1 and may support high AC frequency driving of a mirror 110.

Referring to FIG. 3A, the pixel circuit 300A may include data lines 302 configured to carry (e.g., pass, convey, transfer) data signals that include frame data, such as positive and negative data frames. For example, the pixel circuit 300A may include a data line D+ 302A configured to carry data signals for (e.g., representing) positive data frames and a data line D− 302B configured to carry data signals for negative data frames.

The pixel circuit 300A may further include data transfer transistors 304A, 304B and storage units 306A, 306B. The data transfer transistors 304A, 304B may be configured transfer frame data from the data lines 302A, 302B to the storage units 306A, 306B for storage on the storage units 306A, 306B. For example, the pixel circuit 300A may include a data transfer transistor G1 304A configured to transfer data signals for positive data frames from the data line D+ 302A to a storage unit C1 306A of the pixel circuit 300A. The pixel circuit 300A may also include a data transfer transistor G5 304B configured to transfer data signals for negative data frame from the data line D− 302B to a storage unit C2 306B of the pixel circuit 300A. In some examples, the storage units 306A, 306B may be capacitors.

The pixel circuit 300A may additionally include voltage sources 308A, 308B (e.g., voltage boosters) configured to increase a voltage of the storage units 306A, 306B. For example, the pixel circuit 300A may include a voltage source 308A coupled with the storage unit C1 306A and a voltage source 308B coupled with the storage unit C2 306B. The voltage source 308A may be configured to increase a voltage of the storage unit C1 306A, for example, by switching from providing a ground voltage (e.g., zero volts) to a boost voltage Vb1, and the voltage source 308B may be configured to increase a voltage of the storage unit C2 306B, for example, by switching from providing a ground voltage (e.g., zero volts) to a boost voltage Vb2. In some examples, the boost voltages Vb may be predefined (e.g., preconfigured, pre-selected, desired) voltages. In some examples, the boost voltages Vb may be the same voltage. In some examples, the boost voltages Vb1 and Vb2 may be different voltages.

The pixel circuit 300A may include source follower transistors 310A, 310B coupled with the storage units 306A, 306B. For example, a source follower transistor G2 310A (e.g., a gate of the source follower transistor 310A) may be coupled with the storage unit C1 306A, and a source follower transistor G6 310B (e.g., a gate of the source follower transistor 310B) may be coupled with the storage unit C2 306B. The source follower transistors 310A and 310B (e.g., the dates of the source follower transistors 310A and 310B) may also be coupled with the data transfer transistors 304A and 304B (e.g., sources of the data transfer transistors 304A and 304B), respectively. Voltage sources 312A and 312B may be coupled with a node (e.g., a drain) of the source follower transistors 310A and 310B, respectively, and may be configured to provide a voltage Vdd to the respective nodes.

The pixel circuit 300A may include data update transistors 314A, 314B configured to transfer frame data to drive a mirror (e.g., electrode) of a LCOS device that implements the pixel circuit 300A. For example, a data update transistor G3 314A (e.g., a drain of the data update transistor G3 314A) may be coupled with the source follower transistor G2 310A (e.g., a source of the source follower transistor G2 310A), and a data update transistor G7 314B (e.g., a drain of the data update transistor G7 314B) may be coupled with the source follower transistor G6 310B (e.g., a source of the source follower transistor G6 310B. The pixel circuit 300A may activate (e.g., open the gates of) the data update transistors 314A, 314B and the source follower transistors 310A, 310B to transfer charge from the storage units 306A, 306B to a storage unit Clcd 316 (e.g., a capacitor Clcd) of the pixel circuit 300A. For example, the pixel circuit 300A may activate the data update transistor G3 314A and the source follower transistor G2 310A to transfer charge from the storage unit C1 306A to the storage unit Clcd 316. Similarly, the pixel circuit 300A may activate the data update transistor G7 314B and the source follower transistor G6 310B to transfer charge from the storage unit C2 306B to the storage unit Clcd 316.

The storage unit Clcd 316 may be used to control the mirror of the LCOS device (e.g., the pixel associated with the pixel circuit 300A). For example, the storage unit Clcd 316 may be coupled with the mirror (e.g., the electrode) such that a charge of the storage unit Clcd 316 may control the mirror. The storage unit Clcd 316 may also be coupled with a voltage source 320 configured to provide a voltage Vcom to the storage unit Clcd 316. In some examples, Vcom may be provided by an external driving board associated with (e.g., coupled with) the LCOS device. The source follower transistors 310A, 310B may be configured to isolate the storage unit Clcd 316 from the storage units 306A, 306B.

The pixel circuit 300A may further include a pull-down transistor G4 322 configured to discharge a capacitance of a node 318 common to (e.g., shared by) the data update transistors 314A, 314B, the storage unit Clcd 316, and the pull-down transistor G4 322. In some examples, the node 318 may be referred to as a PE node. The pull-down transistor G4 322 may be coupled with ground, and the pixel circuit 300A may activate the pull-down transistor G4 322 to discharge a capacitance (e.g., residual capacitance, parasitic capacitance) at the node 318 (e.g., discharge the storage unit Clcd 316) to ground. In some examples, the pixel circuit 300A may activate the pull-down transistor G4 322 using a gate signal P.

The pixel circuit 300A may support high AC frequency driving of a mirror (e.g., electrode) of a LCOS device by rapidly switching between activating the data update transistors 314A and 314B. For example, during operation, the pixel circuit 300A may activate (e.g., simultaneously, concurrently) the data transfer transistor G1 304A and the data transfer transistor G5 304B to transfer a first data signal for a positive data frame and a second data signal for a negative data frame to the storage units 306A and 306B, respectively. The LCOS device may be a direct current (DC) balanced device such that driving the mirrors of the LCOS device may include alternately driving positive and negative frame data to the mirrors. The AC frequency of driving the mirror therefore corresponds to the rate at pixel circuit 300A may drive positive and negative frame data to the mirror.

The pixel circuit 300A may alternately open (e.g., switch between activating) the data update transistors 314A and 314B at high frequency to achieve high-frequency driving of the mirror. For example, the pixel circuit 300A may switch between activating the data update transistors 314A and 314B at a first frequency that is independent of a second frequency at which data signals for positive and negative data frames are stored to the storage units 306A, 306B. For instance, the pixel circuit 300A may activate the data transfer transistors 304A, 304B at the second frequency (e.g., switch between activating and deactivating the data transfer transistors 304A, 304B according to the second frequency) to transfer positive and negative frame data to the storage units 306A, 306B. Between activations of the data transfer transistors 304A, 304B, the pixel circuit 300A may repeatedly switch between activating the data update transistors 314A and 314B at the first frequency to repeatedly transfer the positive and negative frame data stored at the storage units 306A and 306B (e.g., charges representing the positive and negative frame data, such as charges boosted by the voltage sources 308A, 308B), respectively, to the storage unit Clcd 316. As such, first frequency at which the pixel circuit 300A activates the data update transistors 314A, 314B may be independent of (e.g., different than) the second frequency at which the pixel circuit 300A activates the data transfer transistors 304A, 304B.

Additionally, the first frequency may be higher than the second frequency. As such, the frequency at which pixel circuit 300A may switch between transferring positive and negative frame data to the storage unit Clcd 316 may be higher than the frequency at which new positive and negative frame data may be transferred to the storage units 306A, 306B, thereby enabling high frequency AC driving of the storage unit Clcd 316.

Further, to increase the output voltage range at the node 318, the voltage sources 308A, 308B may be set to the boost voltages Vb before (e.g., or concurrent with) activating the data update transistors 314A, 314B. For example, before or concurrent with activating the data update transistor 314A, the voltage source 308A may switch from providing a ground voltage to providing the boost voltage Vb1 to the storage unit C1 306A. Before or concurrent with activating the data update transistor 314B, the voltage source 308B may switch from providing a ground voltage to providing the boost voltage Vb2 to the storage unit C2 306B. Accordingly, the voltage sources 308A, 308B may be configured to switch between the ground voltage and the boost voltages Vb based on (e.g., in accordance with, following the sequence of) switching activation of the data update transistors 314A, 314B.

The pixel circuit 300A may also use (e.g., activate) the pull-down transistor G4 322 to discharge the storage unit Clcd 316 (e.g., and peripheral capacitors) before or concurrent with activating the data update transistors 314A, 314B. For example, in some instances, before each activation of the data update transistors 314A, 314B, the pixel circuit 300A may activate the pull-down transistor G4 322 to discharge a capacitance of the node 318. In some examples, the pull-down transistor G4 322 may be activated concurrently with the activation of a data update transistor 314A, 314B. For example, the pull-down transistor G4 322 may be activated before a data update transistor 314A, 314B is activated and may remain activated for a portion of the activation of the data update transistor 314A, 314B. Alternatively, the pull-down transistor G4 322 and the data update transistor 314A, 314B may be activated simultaneously. In either example, a duration of each activation of the pull-down transistor G4 322 may be less than a duration of each activation of the data update transistor 314A, 314B. That is, the pull-down transistor G4 322 may be activated for less time than the data update transistor 314A, 314B is activated.

Referring to FIG. 3B, the pixel circuit 300B may include the same components as, and operate the same as, the pixel circuit 300A, except that the pixel circuit 300B may support a different arrangement of pull-down transistors 322A, 322B, instead of pull-down transistor 322 of pixel circuit 300A. For example, the pixel circuit 300B may include a pull-down transistor G4 322A and a pull-down transistor G8 322B. Rather than being arranged such that the node 318 is common to the pull-down transistor 322, the pull-down transistors 322 of the pixel circuit 300B may be coupled with the source follower transistors 310A, 310B and the data update transistors 314A, 314B. For example, the pull-down transistor G4 322A may be coupled with the source follower transistor 310A and the data update transistor 314A, and the pull-down transistor G8 322B may be coupled with the source follower transistor 310B and the data update transistor 314B.

The operation and function of the pull-down transistors 322A and 322B may be similar to the pull-down transistor 322 of the pixel circuit 300A. For example, the pixel circuit 300B may use (e.g., activate) the pull-down transistors 322A and 322B to discharge the storage unit Clcd 316 (e.g., and peripheral capacitors) before or concurrent with activating the data update transistors 314A, 314B. In some examples, the pull-down transistors 322A and 322B may be controlled separately. For example, the pull-down transistors 322A and 322B may be separately activated using separate gate signals P1 and P2, respectively. If controlled separately, the pull-down transistors 322A and 322B may be activated in accordance with the activation of the data update transistor 314A, 314B to which the pull-down transistors 322A and 322B are, respectively, coupled. For example, the pixel circuit 300B may activate the pull-down transistor G4 322A in accordance with (e.g., before or concurrent with) each activation of the data update transistor G3 314A to discharge a capacitance of the node 318. The pixel circuit 300B may also activate the pull-down transistor G8 322B in accordance with (e.g., before or concurrent with) each activation of the data update transistor G7 314B to discharge a capacitance of the node 318.

In some examples, the pull-down transistors 322A and 322B may be coupled together and configured to switch (e.g., activate) simultaneously. For example, the P1 and P2 gate signals may a same gate signal that controls activation of both the pull-down transistor 322A and the pull-down transistor 322B. Here, the pixel circuit 300B may activate each of the pull-down transistors 322A and 322B in accordance with (e.g., before or concurrent with) each activation of each data update transistor 314 to discharge a capacitance of the node 318. That is, for each activation of the data update transistor 314A and for each activation of the data update transistor 314B, the pixel circuit 300B may activate the pull-down transistors 322A and 322B.

The pixel circuit 300B may offer a lower current leakage for the storage unit Clcd 316 compared to the pixel circuit 300A, which results in a higher VHR, thereby leading to reduced phase flickering in LCOS phase modulators. For example, the current leakage for the storage unit Clcd 316 may be based on the quantity of components for which the node 318 is a common node (e.g., the quantity of components coupled to the storage unit Clcd 316). The greater the quantity of components, the greater the current leakage, as there are a greater quantity of components through which current may leak. The pixel circuit 300B has fewer components coupled with the storage unit Clcd 316 relative to the pixel circuit 300A because the pull-down transistors 322 A, 322B are coupled with the source follower transistors 310A, 310B and the data update transistors 314A, 314B as opposed to the storage unit Clcd 316. Accordingly, the current leakage for the storage unit Clcd 316 may be lower for the pixel circuit 300B than for the pixel circuit 300A.

In some examples, all the transistors included in the pixel circuits 300A and 300B (e.g., the data transfer transistors 304A, 304B, the source follower transistors 310A, 310B, the data update transistors 314A, 314B, the pull-down transistors 322A, 322B) may be n-channel metal-oxide semiconductor (NMOS) transistors.

High frequency switching between the data update transistors 314 enables a LCOS phase modulator to reduce phase flickering, which is essential for certain applications, such as WSS. For example, high AC frequency driving reduces the amount of time during which frame data is not being driven to the node 318, thereby increasing voltage stability at the node 318. High AC frequency driving further helps reduce ion-charge accumulation on the mirrors (e.g., electrodes) of the LCOS device and minimizes the flexoelectric effect, thereby reducing the phase flickering of LCOS phase modulators.

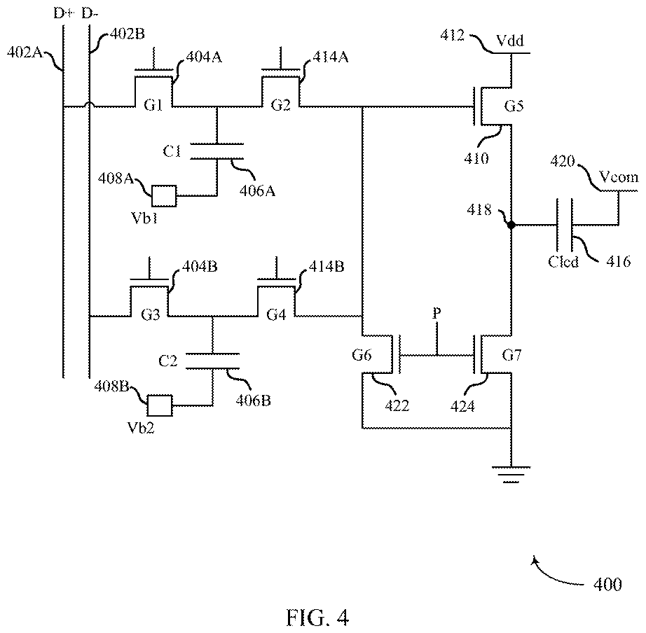

FIG. 4 depicts a pixel circuit 400 that supports improved silicon backplanes for a LCOS phase modulation in accordance with one or more aspects of the present disclosure. The pixel circuit 400 may be implemented in a LCOS device 100, as described with reference to FIG. 1. For example, the pixel circuit 400 may be an example of a circuit 114 described with reference to FIG. 1 and may support improving voltage stability (e.g., maintaining a high VHR) at the mirror 110 by providing continuous charging to an LC capacitor.

The pixel circuit 400 may include data lines 402A, 402B, data transfer transistors 404A, 404B, storage units 406A, 406B, and voltage sources 408A, 408B, which may be similar to data lines 302A, 302B, data transfer transistors 304A, 304B, storage units 306A, 306B, and voltage sources 308A, 308B, respectively, described with reference to FIGS. 3A & 3B. For example, the pixel circuit 400 may include a data line D+ 402A configured to carry data signals for positive data frames and a data line D− 402B configured to carry data signals for negative data frames. The pixel circuit 400 may further include a data transfer transistor 404A configured to transfer data signals for positive data frames from the data line D+ 402A to a storage unit C1 406A and a data transfer transistor 404B configured to transfer data signals for negative data frames from the data line D− 402B to a storage unit C2 406B. Additionally, a voltage source 408A may be coupled with and configured to increase a voltage of the storage unit C1 406A, and a voltage source 408B may be coupled with and configured to increase a voltage of the storage unit C2 406B. The voltage sources 408A, 408B may be configured to increase the voltages of the respective storage units 406A, 406B by switching from providing a ground voltage to a boost voltage (e.g., Vb1 and Vb2, respectively).

The pixel circuit 400 may include data update transistors 414A, 414B coupled with respective storage units 406A, 406B and a source follower transistor G5 410. For example, the pixel circuit 400 may include a data update transistor G2 414A (e.g., a drain of the data update transistor G2 414A) coupled with the storage unit C1 406A and a data update transistor G4 414B (e.g., a drain of the data update transistor G4 414B) coupled with the storage unit C2 406B. The source follower transistor G5 410 (e.g., a gate of the source follower transistor G5 410) may be coupled with each of the data update transistor G2 414A and the data update transistor G4 414B (e.g., each source of the data update transistors 414A, 414B). A voltage source 412 may be coupled with a node (e.g., a drain) of the source follower transistor G5 410 and may be configured to provide a voltage Vdd to the node.

The data update transistors 414A, 414B may be configured to transfer frame data to drive a mirror (e.g., electrode) of a LCOS device that implements the pixel circuit 400. For example, the pixel circuit 400 may activate (e.g., open the gates of) the data update transistors 414A, 414B to transfer charge from the storage units 406A, 406B to a storage unit Clcd 416 (e.g., a capacitor Clcd) via the source follower transistor G5 410. For instance, the pixel circuit 400 may activate the data update transistor G2 414A to transfer charge from the storage unit C1 406A to the storage unit Clcd 416 via the source follower transistor G5 410. Similarly, the pixel circuit 400 may activate the data update transistor G4 414B to transfer charge from the storage unit C2 406B to the storage unit Clcd 416 via the source follower transistor G5 410.

The storage unit Clcd 416 may be similar to the storage unit Clcd 316 described with reference to FIGS. 3A and 3B. For example, the storage unit Clcd 416 may be used to control the mirror of the LCOS device (e.g., the pixel associated with the pixel circuit 400). The storage unit Clcd 416 may be coupled with a voltage source 420 (which may be similar to the voltage source 320) configured to provide a voltage Vcom to the storage unit Clcd 416.

The pixel circuit 400 may further include a pull-down transistor G6 422 configured to discharge a capacitance of a gate of the source follower transistor G5 410 and a pull-down transistor G7 424 configured to discharge a capacitance of a node 418 common to (e.g., shared by) the source follower transistor G5 410, the storage unit Clcd 416, and the pull-down transistor G7 424. In some examples, the node 418 may be referred to as a PE node. The pull-down transistor G6 422 and the pull-down transistor G7 424 may be coupled with ground. In some examples, the pull-down transistors 422 and 424 may be coupled together and configured to switch simultaneously. For example, as shown in FIG. 4, the pixel circuit 400 may activate the pull-down transistors 422 and 424 using a gate signal P. In some other examples, the pull-down transistors 422 and 424 may be controlled (e.g., activated) separately, for example, if activated using separate gate signals. The pixel circuit 400 may activate the pull-down transistor G6 322 to discharge a capacitance (e.g., residual capacitance, parasitic capacitance) at the gate of the source follower transistor G5 410 to ground. The pixel circuit 400 may activate the pull-down transistor G7 424 to discharge a capacitance at the node 418 (e.g., discharge the storage unit Clcd 416) to ground.

The pixel circuit 400 may support improving voltage stability (e.g., maintaining a high VHR) at a mirror (e.g., electrode) of a LCOS device by providing continuous charging to the storage unit Clcd 416. For example, during operation, the pixel circuit 400 may activate the data transfer transistor G1 404A to transfer a first data signal for a positive data frame to the storage unit C1 406A.

In some examples, positive frame data may be loaded through respective data transfer transistors G1 404A, 404B and stored on respective storage units C1 406A, 406B in all pixels of a LCOS device. That is, each pixel circuit 400 in the LCOS device may activate a respective data transfer transistor G1 404A to transfer a respective first data signal for the positive data frame to a respective storage unit C1 406A. After the positive data frame is loaded (e.g., transferred) to all the respective storage units C1 406A, 406B (e.g., after all respective first data signals are stored to the respective storage units C1 406A, 406B), each pixel circuit 400 in the LCOS device may activate respective data update transistors G2 414A (e.g., the G2 gates in all pixels may be opened) to transfer respective first charges from the respective storage units C1 406A to the storage unit Clcd 416 via the source follower transistor G5 410. The respective first charges may be based on (e.g., represent, correspond to) the respective first data signals.

While the positive data frame is being displayed by the mirrors of the LCOS device (e.g., while the respective data update transistors 414A are activated and transferring the respective first charges to the respective storage units Clcd 416), negative frame data may be loaded through respective data transfer transistors G3 404B and stored on respective storage units C2 406B. For example, concurrent with the respective data update transistors 414A, 414B transferring the respective first charges, each pixel circuit 400 may be configured to activate respective data transfer transistors G3 404B to transfer respective second data signals for a negative data frame to respective storage units C2 406B. After the negative data frame is loaded (e.g., transferred) to all the respective storage units C2 406B (e.g., after all respective second data signals are stored to the respective storage units C2 406B), each pixel circuit 400 in the LCOS device may deactivate (e.g., close) the respective data update transistors 414A. Each pixel circuit 400 may further activate respective data update transistors G4 414B (e.g., the G4 gates in all pixels may be opened) to transfer respective second charges from the respective storage units C2 406B to the storage unit Clcd 416 via the source follower transistor G5 410. As such, the negative data frame may be displayed by the LCOS device.

Similarly, while the negative data frame is being displayed by the mirrors of the LCOS device (e.g., while the respective data update transistors 414B are activated and transferring the respective second charges to the respective storage units Clcd 416), a subsequent positive frame data may be loaded through respective data transfer transistors G1 404A and stored on respective storage units C1 406A. That is, concurrent with the respective data update transistors 414A, 414B transferring the respective second charges, each pixel circuit 400 may be configured to activate respective data transfer transistors G1 404A to transfer respective first data signals for a subsequent positive data frame to respective storage units C1 406A.

The pixel circuits 400 may continue switching between activating the data update transistors 414A, 414B while loading positive or negative data frames to the other storage units 406A, 406B. Such operation method enables frame-by-frame data updates and ensures high-voltage stability applied to LC elements (e.g., the mirrors of the LCOS device). For example, because positive data frames are loaded while negative data frames are being displayed, and vice versa, the pixel circuit 400 may switch between activating the data update transistors 414A and 414B such that charge is continuously supplied to the storage unit Clcd 416 from either the storage unit C1 406A or the storage unit C2 406B.

Further, to increase the output voltage range at the node 418, the voltage sources 408A, 408B may be set to the boost voltages Vb before (e.g., or concurrent with) activating the data update transistors 414A, 414B. For example, before or concurrent with activating the data update transistor 414A, the voltage source 408A may switch from providing a ground voltage to providing the boost voltage Vb1 to the storage unit C1 406A. Before or concurrent with activating the data update transistor 414B, the voltage source 408B may switch from providing a ground voltage to providing the boost voltage Vb2 to the storage unit C2 406B. Accordingly, the voltage sources 408 may be configured to switch between the ground voltage and the boost voltages Vb based on (e.g., in accordance with, following the sequence of) switching activation of the data update transistors 414A, 414B.

The pixel circuit 400 may also activate, before or concurrent with activating the data update transistors 414A, 414B, the pull-down transistors 422 and 424 to discharge the gate capacitance of the source follower transistor G5 410 and the capacitance of the storage unit Clcd 416 (e.g., and peripheral capacitors), respectively. For example, in accordance with (e.g., before or concurrent with) each activation of the data update transistor 414A, the pixel circuit 400 may activate the pull-down transistors 422 and 424 to discharge the gate capacitance of the source follower transistor G5 410 and the capacitance of the node 418, respectively. Additionally, in accordance with (e.g., before or concurrent with) each activation of the data update transistor 414B, the pixel circuit 400 may activate the pull-down transistors 422 and 424 to discharge the gate capacitance of the source follower transistor G5 410 and the capacitance of the node 418, respectively.

In some examples, all the transistors included in the pixel circuit 400 (e.g., the data transfer transistors 404A, 404B, the source follower transistor 410, the data update transistors 314A, 314B, the pull-down transistors 422 and 424) may be NMOS transistors.

Continuously charging an LC capacitor Clcd (e.g., the storage unit Clcd 416) within one frame time, as supported by the pixel circuit 400, may greatly enhancing voltage stability. Additionally, the source follower transistor G5 410 may be configured to isolate the storage units 406A, 406B from the storage unit Clcd 416, further improving voltage stability applied to the LC elements. The increased stability of the pixel output voltage also reduces phase flickering in LCOS phase modulators.

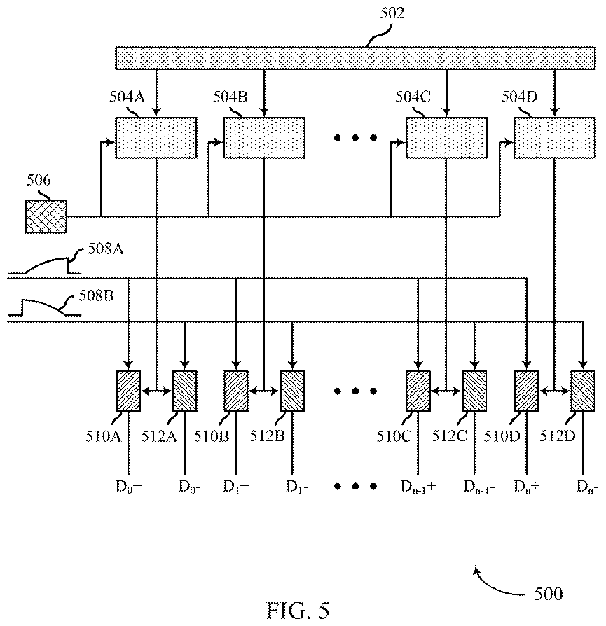

FIG. 5 depicts a driving circuit 500 that supports improved silicon backplanes for a LCOS phase modulation in accordance with one or more aspects of the present disclosure. The driving circuit 500 may be implemented in the LCOS device 100, as described with reference to FIG. 1. For example, the driving circuit 500 may be an example of the driving circuit 116 described with reference to FIG. 1 and may support implementing a simplified sample-hold DAC-type column driver for driving data to the circuit 114.

The driving circuit 500 may be configured to drive data signals for positive data frames and negative data frames to pixel circuits of a LCOS device (e.g., circuits 114, pixel circuits 300A, 300B, 400). The driving circuit 500 may include register circuitry 502 configured to receive serial digital data inputs and latch rows of pixel data for controlling the electrodes of a LCOS backplane phase modulator (e.g., mirrors 110). For example, the register circuitry 502 may include shift registers configured to receive the serial digital data inputs and data registers configured to latch the rows of the pixel data based on the serial digital data inputs received by the shift registers.

The driving circuit 500 may further include a quantity of comparators 504A, 504B, 504C, 504D. In some examples, the quantity of comparators 504A to 504D may equal a quantity of pairs of positive and negative data input lines of the LCOS device used to drive data frames to the pixel circuits. The comparators 504A to 504D may be configured to receive the pixel data from the data registers and a clock signal from a counter 506. In some examples, the clock signal may be a gray level clock signal. In some examples, the counter 506 may be a 10-bit counter. In some examples, the counter 506 may be a gray level counter.

The driving circuit 500 may include signal input circuitry configured to input positive and negative signals. In the example of FIG. 5, the signal input circuitry may be ramp signal input circuitry configured to input a positive ramp signal 508A and a negative ramp signal 508B. For example, the positive and negative signals (e.g., the positive ramp signal 508A and a negative ramp signal 508B) may be generated externally from the LCOS backplane (e.g., by an external driving board of the LCOS device). The signal input circuitry (e.g. the ramp signal input circuitry) may be configured to receive the externally generated positive and negative signals and provide the positive and negative signals as inputs to the driving circuit 500 (e.g., inputs to sample-hold circuitry of the driving circuit 500).

The driving circuit 500 may include sample-hold circuitry. For example, the sample-hold circuitry may include sample-hold components 510A to 512D configured to sample and hold the positive ramp signal 508A and sample-hold components 512A to 512D configured to sample and hold the negative ramp signal 508B. In the example of FIG. 5, the sample-hold circuitry includes sample-hold components 510A, 510B, 510C, and 510D and sample-hold components 512A, 512B, 512C, and 512D.

The comparators 504A to 504D may be configured to generate output signals based on the pixel data and the clock signal and output the output signals to the sample-hold circuitry. The sample-hold circuitry may be configured to output analog data signals for positive and negative data frames based on the output signals and the positive and negative ramp signals 508A and 508B. For example, the sample-hold components 510A to 510D and 512A to 512D may sample the respective ramp signals 508A and 508B based on the output signals and output respective analog signals based on the sampled ramp signal 508A, 508B. For instance, the sample-hold component 510A and the sample-hold component 512A may sample and hold the positive ramp signal 508A and the negative ramp signal 508B, respectively, based on an output signal received from the comparator 504A; the sample-hold component 510B and the sample-hold component 512B may sample and hold the positive ramp signal 508A and the negative ramp signal 508B, respectively, based on an output signal received from the comparator 504B; and so on. Based on the sampled ramp signals 508A, 508B, the sample-hold component 510A may output a first analog signal for a positive data frame to a data line D₀+; the sample-hold component 512A may output a first analog signal for a negative data frame to a data line D₀−; the sample-hold component 510B may output a second analog signal for the positive data frame to a data line D₁+; the sample-hold component 512B may output a second analog signal for the negative data frame to a data line D₁−; and so on. In this way, the driving circuit 500 may drive data signals (e.g., analog signals) for positive data frames and negative data frames to pixel circuits of the LCOS device.

The comparators 504A to 504D and sample-hold circuitry enables a simplified DAC-type column driver that supports using a variety of waveforms for the positive and negative input signals (e.g., as opposed to being limited to a sawtooth waveform). Alternative waveforms, such as the ramp signals 508A, 508B, may facilitate Gamma calibration and DC bias fine-tuning through the optimization of the positive and negative input ramp signals. The driving circuit 500 may be a simpler circuit relative to (e.g., that occupies less space than) conventional R-DAC column drivers by utilizing positive and negative input signals (e.g., ramp signals) that are externally generated. The sample-hold DAC of the driving circuit 500 may further support higher resolution compared to a conventional R-DAC commonly implemented in LCOS and TFT column drivers.

The following provides an overview of aspects of the present disclosure:

Aspect 1: A circuit for controlling an electrode of a LCOS backplane phase modulator, comprising: a first data transfer transistor; a second data transfer transistor; a first storage unit coupled with the first data transfer transistor and configured to store a first data signal for a positive data frame transferred via the first data transfer transistor; a second storage unit coupled with the second data transfer transistor and configured to store a second data signal for a negative data frame transferred via the second data transfer transistor; a first voltage source configured to increase a voltage of the first storage unit; a second voltage source configured to increase a voltage of the second storage unit; a first source follower transistor coupled with the first storage unit; a second source follower transistor coupled with the second storage unit; a first data update transistor coupled with the first source follower transistor; a second data update transistor coupled with the second source follower transistor; a third storage unit coupled with the electrode of the LCOS backplane phase modulator; and a pull-down transistor configured to discharge a capacitance of a node common to the first data update transistor, the second data update transistor, and the third storage unit, wherein: the first data update transistor is configured to transfer a first charge to the third storage unit based at least in part on the first data signal for the positive data frame; the second data update transistor is configured to transfer a second charge to the third storage unit based at least in part on the second data signal for the negative data frame; and the circuit is configured to switch between activating the first data update transistor and the second data update transistor at a first frequency that is independent of a second frequency at which data signals for positive and negative data frames are stored to the first and second storage units.

Aspect 2: The circuit of aspect 1, wherein: the first source follower transistor is configured to isolate the third storage unit from the first storage unit; and the second source follower transistor is configured to isolate the third storage unit from the second storage unit.

Aspect 3: The circuit of any of aspects 1 through 2, wherein the first frequency at which the circuit is configured to switch between activating the first and second data update transistors is higher than the second frequency at which the data signals for the positive and negative data frames are stored.

Aspect 4: The circuit of any of aspects 1 through 3, wherein the first data signal for the positive data frame and the second data signal for the negative data frame are concurrently transferred to the first and second storage units.

Aspect 5: The circuit of any of aspects 1 through 4, wherein the first and second voltage sources are configured to switch between providing a ground voltage and a boost voltage to the first and second storage units, respectively.

Aspect 6: The circuit of aspect 5, wherein the first and second voltage sources are configured to switch between the ground voltage and the boost voltage based at least in part on the switching of the first data update transistor and the second data update transistor.

Aspect 7: The circuit of any of aspects 1 through 6, wherein the pull-down transistor is coupled with the third storage unit such that the node is further common to the pull-down transistor.

Aspect 8: The circuit of any of aspects 1 through 6, further comprising: a second pull-down transistor configured to discharge the capacitance of the node.

Aspect 9: The circuit of aspect 8, wherein: the pull-down transistor is coupled with the first source follower transistor and the first data update transistor; and the second pull-down transistor is coupled with the second source follower transistor and the second data update transistor.

Aspect 10: The circuit of any of aspects 8 through 9, wherein the circuit is configured to switch between activating the pull-down transistor and the second pull-down transistor based at least in part on switching between activating the first data update transistor and the second data update transistor.

Aspect 11: The circuit of any of aspects 8 through 9, wherein: the pull-down transistor and the second pull-down transistor are coupled together; and the circuit is configured to activate the pull-down transistor and the second pull-down transistor simultaneously based at least in part on switching between activating the first data update transistor and the second data update transistor.

Aspect 12: The circuit of any of aspects 1 through 11, wherein first and second data transfer transistors, the first and second source follower transistors, and the first and second data update transistors are NMOS transistors.

Aspect 13: A LCOS device, comprising: a transparent glass substrate; a transparent electrode; a silicon backplane; liquid crystal disposed between the silicon backplane and the transparent electrode; and an array of mirrors disposed on the silicon backplane, wherein the silicon backplane comprises a plurality of the circuit of any of aspects 1 through 12, each circuit of the plurality coupled with a respective mirror of the array of mirrors, the respective mirror being the electrode coupled with the third storage unit of each circuit.

Aspect 14: A method for operating a circuit to control an electrode of a LCOS backplane phase modulator, comprising: storing, via a first data transfer transistor of the circuit, a first data signal for a positive data frame to a first storage unit of the circuit; storing, via a second data transfer transistor of the circuit, a second data signal for a negative data frame to a second storage unit of the circuit; increasing, using a first voltage source of the circuit, a first voltage of the first storage unit; increasing, using a second voltage source of the circuit, a second voltage of the second storage unit; activating a first data update transistor of the circuit to transfer a first charge from the first storage unit to a third storage unit of the circuit that is coupled with the electrode of the LCOS backplane phase modulator via the first data update transistor and a first source follower transistor of the circuit; activating a second data update transistor of the circuit to transfer a second charge from the second storage unit to the third storage unit via the second data update transistor and a second source follower transistor of the circuit; and switching activation of the first data update transistor and the second data update transistor at a first frequency that is independent of a second frequency at which data signals for positive and negative frames are stored to the first and second storage units.

Aspect 15: The method of aspect 14, further comprising: activating, in accordance with each activation of the first and second data update transistors, a pull-down transistor of the circuit to discharge a capacitance of a node common to the first data update transistor, the second data update transistor, and the third storage unit.

Aspect 16: The method of aspect 14, further comprising: activating, in accordance with each activation of the first data update transistor, a first pull-down transistor of the circuit to discharge a capacitance of a node common to the first data update transistor, the second data update transistor, and the third storage unit; and activating, in accordance with each activation of the second data update transistor, a second pull-down transistor of the circuit to discharge the capacitance of the node.

Aspect 17: The method of aspect 14, further comprising: activating, in accordance with each activation of the first and second data update transistors, a first pull-down transistor of the circuit and a second pull-down transistor of the circuit to discharge a capacitance of a node common to the first data update transistor, the second data update transistor, and the third storage unit.

Aspect 18: The method of any of aspects 14 through 17, wherein the first frequency is higher than the second frequency.

Aspect 19: The method of any of aspects 14 through 18, wherein the first data signal for the positive data frame and the second data signal for the negative data frame are concurrently stored to the first and second storage units.

Aspect 20: A circuit for controlling an electrode of a LCOS backplane phase modulator, comprising: a first data transfer transistor; a second data transfer transistor; a first storage unit coupled with the first data transfer transistor and configured to store a first data signal for a positive data frame transferred via the first data transfer transistor; a second storage unit coupled with the second data transfer transistor and configured to store a second data signal for a negative data frame transferred via the second data transfer transistor; a first voltage source configured to increase a voltage of the first storage unit; a second voltage source configured to increase a voltage of the second storage unit; a first data update transistor coupled with the first storage unit; a second data update transistor coupled with the second storage unit; a source follower transistor coupled with the first data update transistor and the second data update transistor; a third storage unit coupled with the electrode of the LCOS backplane phase modulator; a first pull-down transistor configured to discharge a capacitance of a gate of the source follower transistor; and a second pull-down transistor configured to discharge a capacitance of a node common to the source follower transistor, the third storage unit, and the second pull-down transistor, wherein: the first data update transistor is configured to transfer a first charge to the third storage unit via the source follower transistor based at least in part on the first data signal for the positive data frame; and the second data update transistor is configured to transfer a second charge to the third storage unit via the source follower transistor based at least in part on the second data signal for the negative data frame.

Aspect 21: The circuit of aspect 20, wherein the source follower transistor is configured to isolate the third storage unit from the first storage unit and the second storage unit.

Aspect 22: The circuit of any of aspects 20 through 21, wherein the first and second voltage sources are configured to switch between providing a ground voltage and a boost voltage to the first and second storage units, respectively.

Aspect 23: The circuit of claim any of aspects 20 through 22, wherein the first pull-down transistor and the second pull-down transistor are configured to be activated simultaneously to discharge the capacitance of the gate of the source follower transistor and the capacitance of the node, respectively.

Aspect 24: The circuit of any of aspects 20 through 23, wherein: the first data transfer transistor is configured to transfer the first data signal to the first storage unit concurrent with the second data update transistor transferring the second charge to the third storage unit; and the second data transfer transistor is configured to transfer the second data signal to the second storage unit concurrent with the first data update transistor transferring the first charge to the third storage unit.

Aspect 25: The circuit of any of aspects 20 through 24, wherein first and second data transfer transistors, the first and second data update transistors, and the source follower transistor are NMOS transistors.

Aspect 26: A LCOS device, comprising: a transparent glass substrate; a transparent electrode; a silicon backplane; liquid crystal disposed between the silicon backplane and the transparent electrode; and an array of mirrors disposed on the silicon backplane, wherein the silicon backplane comprises a plurality of the circuit of any of aspects 20 through 25, each circuit of the plurality coupled with a mirror of the array of mirrors, the respective mirror being the electrode coupled with the third storage unit of each circuit.

Aspect 27: The LCOS of aspect 26, wherein: the first data update transistor is configured to transfer the first charge to the third storage unit after all data signals for the positive data frame are stored to corresponding first storage units of the plurality; and the second data update transistor is configured to transfer the second charge to the third storage unit after all data signals for the negative data frame are stored to corresponding second storage units of the plurality.

Aspect 28: A method for operating a circuit to control an electrode of a LCOS backplane phase modulator, comprising: storing, via a first data transfer transistor of the circuit, a first data signal for a positive data frame to a first storage unit of the circuit; increasing, using a first voltage source of the circuit, a first voltage of the first storage unit; activating a first data update transistor of the circuit to transfer a first charge from the first storage unit to a second storage unit of the circuit that is coupled with the electrode of the LCOS backplane phase modulator via the first data update transistor and a source follower transistor of the circuit; storing, via a second data transfer transistor of the circuit and during the activation of the first data update transistor, a second data signal for a negative data frame to a third storage unit of the circuit; increasing, using a second voltage source of the circuit, a second voltage of the third storage unit; and activating a second data update transistor of the circuit to transfer a second charge from the second storage unit to the third storage unit via the second data update transistor and the source follower transistor of the circuit.

Aspect 29: The method of aspect 28, further comprising: activating, based on activating the first data update transistor, a first pull-down transistor of the circuit to discharge a capacitance of a gate of the source follower transistor; and activating, based on activating the first data update transistor, a second pull-down transistor of the circuit to discharge a capacitance of a node common to the source follower transistor and the third storage unit.

Aspect 30: The method of aspect 29, further comprising: activating, based on activating the second data update transistor, the first pull-down transistor to discharge the capacitance of the gate of the source follower transistor; and activating, based on activating the second data update transistor, the second pull-down transistor to discharge the capacitance of the node.

Aspect 31: The method of any of aspects 28 through 30, further comprising: storing, via the first data transfer transistor and during the activation of the second data update transistor, a third data signal for a second positive data frame to the first storage unit.

Aspect 32: A circuit for driving data signals to control electrodes of a LCOS backplane phase modulator, comprising: ramp signal input circuitry configured to generate input positive and negative ramp signals; shift registers configured to receive serial digital data inputs; data registers configured to latch rows of pixel data for controlling the electrodes; signal comparators configured to receive the pixel data and a clock signal and generate output signals based at least in part on the pixel data and the clock signal; and sample-hold circuitry configured to receive the output signals from the signal comparators and the positive and negative ramp signals from the ramp signal input circuitry and to output analog data signals for positive and negative data frames based at least in part on the output signals and the positive and negative ramp signals.

Aspect 33: The circuit of aspect 32, wherein the ramp signal input circuitry generates the positive and negative ramp signals externally from the LCOS backplane phase modulator.

Aspect 34: The circuit of any of aspects 32 through 33, wherein the signal comparators and the sample-hold circuitry operate as sample-hold DACs.

Aspect 35: The circuit of any of aspects 32 through 34, wherein the circuit excludes a R-DAC.

The terminology used in the present disclosure is for the purpose of describing particular embodiments only and is not intended to limit the present disclosure. As used in the present disclosure and the appended claims, the singular forms “a,” “an,” and “the” are intended to include the plural forms as well, unless the context clearly indicates otherwise. It shall also be understood that the term “and/or” used herein is intended to signify and include any or all possible combinations of one or more items listed in the associated list.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

It shall be understood that although the terms “first,” “second,” “third,” etc. may be used herein to describe various information, the information should not be limited by these terms. These terms are only used to distinguish one category of information from another. For example, without departing from the scope of the present disclosure, the first information may be termed as second information, and similarly, the second information may also be termed as first information.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and second condition or action may at least partially occur as a result of the previous condition or action occurring (whether directly after or after one or more other intermediate conditions or actions occurring after the first condition or action).

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A circuit for controlling an electrode of a liquid crystal on silicon (LCOS) backplane phase modulator, comprising:
a first data transfer transistor;
a second data transfer transistor;
a first storage unit coupled with the first data transfer transistor and configured to store a first data signal for a positive data frame transferred via the first data transfer transistor;
a second storage unit coupled with the second data transfer transistor and configured to store a second data signal for a negative data frame transferred via the second data transfer transistor;
a first voltage source configured to increase a voltage of the first storage unit;
a second voltage source configured to increase a voltage of the second storage unit;
a first source follower transistor coupled with the first storage unit;
a second source follower transistor coupled with the second storage unit;
a first data update transistor coupled with the first source follower transistor;
a second data update transistor coupled with the second source follower transistor;
a third storage unit coupled with the electrode of the LCOS backplane phase modulator; and
a pull-down transistor configured to discharge a capacitance of a node common to the first data update transistor, the second data update transistor, and the third storage unit,
wherein:
the first data update transistor is configured to transfer a first charge to the third storage unit based at least in part on the first data signal for the positive data frame;
the second data update transistor is configured to transfer a second charge to the third storage unit based at least in part on the second data signal for the negative data frame; and
the circuit is configured to switch between activating the first data update transistor and the second data update transistor at a first frequency that is independent of a second frequency at which data signals for positive and negative data frames are stored to the first and second storage units.

2. The circuit of claim 1, wherein:
the first source follower transistor is configured to isolate the third storage unit from the first storage unit; and
the second source follower transistor is configured to isolate the third storage unit from the second storage unit.

3. The circuit of claim 1, wherein the first frequency at which the circuit is configured to switch between activating the first and second data update transistors is higher than the second frequency at which the data signals for the positive and negative data frames are stored.

4. The circuit of claim 1, wherein the first data signal for the positive data frame and the second data signal for the negative data frame are concurrently transferred to the first and second storage units.

5. The circuit of claim 1, wherein the first and second voltage sources are configured to switch between providing a ground voltage and a boost voltage to the first and second storage units, respectively.

6. The circuit of claim 5, wherein the first and second voltage sources are configured to switch between the ground voltage and the boost voltage based at least in part on the switching of the first data update transistor and the second data update transistor.

7. The circuit of claim 1, wherein the pull-down transistor is coupled with the third storage unit such that the node is further common to the pull-down transistor.

8. The circuit of claim 1, further comprising:
a second pull-down transistor configured to discharge the capacitance of the node.

9. The circuit of claim 8, wherein:
the pull-down transistor is coupled with the first source follower transistor and the first data update transistor; and
the second pull-down transistor is coupled with the second source follower transistor and the second data update transistor.

10. The circuit of claim 8, wherein the circuit is configured to switch between activating the pull-down transistor and the second pull-down transistor based at least in part on switching between activating the first data update transistor and the second data update transistor.

11. The circuit of claim 8, wherein:
the pull-down transistor and the second pull-down transistor are coupled together; and
the circuit is configured to activate the pull-down transistor and the second pull-down transistor simultaneously based at least in part on switching between activating the first data update transistor and the second data update transistor.

12. A method for operating a circuit to control an electrode of a liquid crystal on silicon (LCOS) backplane phase modulator, comprising:
storing, via a first data transfer transistor of the circuit, a first data signal for a positive data frame to a first storage unit of the circuit;
storing, via a second data transfer transistor of the circuit, a second data signal for a negative data frame to a second storage unit of the circuit;
increasing, using a first voltage source of the circuit, a first voltage of the first storage unit;
increasing, using a second voltage source of the circuit, a second voltage of the second storage unit;
activating a first data update transistor of the circuit to transfer a first charge from the first storage unit to a third storage unit of the circuit that is coupled with the electrode of the LCOS backplane phase modulator via the first data update transistor and a first source follower transistor of the circuit;
activating a second data update transistor of the circuit to transfer a second charge from the second storage unit to the third storage unit via the second data update transistor and a second source follower transistor of the circuit; and
switching activation of the first data update transistor and the second data update transistor at a first frequency that is independent of a second frequency at which data signals for positive and negative frames are stored to the first and second storage units.

13. The method of claim 12, further comprising:
activating, in accordance with each activation of the first and second data update transistors, a pull-down transistor of the circuit to discharge a capacitance of a node common to the first data update transistor, the second data update transistor, and the third storage unit.

14. The method of claim 12, further comprising:
activating, in accordance with each activation of the first data update transistor, a first pull-down transistor of the circuit to discharge a capacitance of a node common to the first data update transistor, the second data update transistor, and the third storage unit; and
activating, in accordance with each activation of the second data update transistor, a second pull-down transistor of the circuit to discharge the capacitance of the node.

15. The method of claim 12, further comprising:
activating, in accordance with each activation of the first and second data update transistors, a first pull-down transistor of the circuit and a second pull-down transistor of the circuit to discharge a capacitance of a node common to the first data update transistor, the second data update transistor, and the third storage unit.

16. A circuit for controlling an electrode of a liquid crystal on silicon (LCOS) backplane phase modulator, comprising:
a first data transfer transistor;
a second data transfer transistor;
a first storage unit coupled with the first data transfer transistor and configured to store a first data signal for a positive data frame transferred via the first data transfer transistor;
a second storage unit coupled with the second data transfer transistor and configured to store a second data signal for a negative data frame transferred via the second data transfer transistor;
a first voltage source configured to increase a voltage of the first storage unit;
a second voltage source configured to increase a voltage of the second storage unit;
a first data update transistor coupled with the first storage unit;
a second data update transistor coupled with the second storage unit;
a source follower transistor coupled with the first data update transistor and the second data update transistor;
a third storage unit coupled with the electrode of the LCOS backplane phase modulator;
a first pull-down transistor configured to discharge a capacitance of a gate of the source follower transistor; and
a second pull-down transistor configured to discharge a capacitance of a node common to the source follower transistor, the third storage unit, and the second pull-down transistor,
wherein:
the first data update transistor is configured to transfer a first charge to the third storage unit via the source follower transistor based at least in part on the first data signal for the positive data frame; and
the second data update transistor is configured to transfer a second charge to the third storage unit via the source follower transistor based at least in part on the second data signal for the negative data frame.

17. The circuit of claim 16, wherein the source follower transistor is configured to isolate the third storage unit from the first storage unit and the second storage unit.

18. The circuit of claim 16, wherein the first and second voltage sources are configured to switch between providing a ground voltage and a boost voltage to the first and second storage units, respectively.

19. The circuit of claim 16, wherein the first pull-down transistor and the second pull-down transistor are configured to be activated simultaneously to discharge the capacitance of the gate of the source follower transistor and the capacitance of the node, respectively.

20. The circuit of claim 20, wherein:
the first data transfer transistor is configured to transfer the first data signal to the first storage unit concurrent with the second data update transistor transferring the second charge to the third storage unit; and
the second data transfer transistor is configured to transfer the second data signal to the second storage unit concurrent with the first data update transistor transferring the first charge to the third storage unit.
